(19) United States
(12) Patent Application Publication
(10) Pub. No.: US 2016/0153797 A1
(43) Pub. Date: Jun. 2, 2016

(54) APPARATUS AND METHOD FOR GUIDING DRIVING ROUTE USING PHOTOGRAPHIC IMAGE

(71) Applicant: HYUNDAI MOBIS CO., LTD., Seoul (KR)

(72) Inventor: Nack Hyun KIM, Yongin (KR)

(21) Appl. No.: 14/593,747

(22) Filed: Jan. 9, 2015

(30) Foreign Application Priority Data
Nov. 28, 2014 (KR) 10-2014-0168513

(51) Int. Cl. G01C 21/34

(52) U.S. Cl. CPC G01C 21/3476

(57) ABSTRACT

The present invention suggests an apparatus and a method for guiding a driving route of a vehicle which guide a driving route at a point of interest based on a photographic image which is obtained by accessing a server. The present invention provides an apparatus, including: a point-of-interest selecting unit which selects a point of interest on a driving route of a vehicle; a moving route image obtaining unit which, when the point of interest is selected, accesses a server to obtain a moving route image for the point of interest based on a photographic image; a point-of-interest approaching determining unit which determines whether the vehicle approaches the point of interest; and a route guiding control unit which, when the vehicle is determined to approach the point of interest, guides the driving route at the point of interest based on the moving route image for the point of interest.

### CROSS-REFERENCE TO RELATED APPLICATIONS

This application claims priority to and the benefit of Korean Patent Application No. 10-2014-0168513 filed in the Korean Intellectual Property Office on Nov. 28, 2014, the entire contents of which are incorporated herein by reference.

### TECHNICAL FIELD

The present invention relates to an apparatus and a method for guiding a driving route of a vehicle and more particularly, to an apparatus and a method for guiding a driving route of a vehicle using a photographic image.

### BACKGROUND ART

An automotive navigation system searches for a destination based on map data and provides information on a road to a driver. In an expressway or a motorway, a screen is divided to display an intersection and an entrance/exit ramp of the road. On the divided screen, a route is displayed on a picture having a shape similar to a junction of an actual road to be shown by the driver.

When the picture which is similar to the road is displayed on the divided screen, it is very helpful for the driver to understand a position or a direction of an entrance/exit ramp. In some navigation systems, an actual image obtained by photographing an actual road is used. An actual image such as an actual road shape, a geographic feature, or a sign is helpful for a driver.

However, a shape of the road which is shown through the divided screen may be different from a real road. When a geographic feature such as surrounding mountain or river or a building, other than the shape of the road, is not reflected, the screen may be shown to be different from the real road. Further, the sign or a road surface marking of the road may be also different from the real one, so that the driver may be confused.

In order to compensate the above-mentioned problem, as suggested in Korean Unexamined Patent Application Publication No. 2012-0060283, a photographed picture which is captured from a vehicle may be used on the divided screen. However, when the images are stored in the navigation system, a large storage capacity is required and it is not easy to update the navigation system. Further, a preferred photographing position or viewing angle may vary depending on drivers, so that usefulness may be lowered.

### SUMMARY OF THE INVENTION

The present invention has been made in an effort to provide an apparatus and a method for guiding a driving route of a vehicle using a photographic image which guide a driving route at a point of interest based on a photographic image obtained by accessing a server.

However, an object of the present invention is not limited to the above description and other objects which have not been mentioned above will be more apparent to those skilled in the art from a reading of the following description.

An exemplary embodiment of the present invention provides an apparatus for guiding a driving route, including: a point-of-interest selecting unit which selects a point of interest on a driving route of a vehicle; a moving route image obtaining unit which, when the point of interest is selected, accesses a server to obtain a moving route image for the point of interest based on a photographic image; a point-of-interest approaching determining unit which determines whether the vehicle approaches the point of interest; and a route guiding control unit which, when it is determined that the vehicle approaches the point of interest, guides the driving route at the point of interest based on the moving route image for the point of interest.

The moving route image obtaining unit may access the server using a telematics function which is installed in the vehicle.

The moving route image obtaining unit may obtain the moving route image at the point of interest obtained by combining a photographic image for the point of interest and an indicator of a moving direction of the vehicle on the driving route based on the current position of the vehicle.

The moving route image obtaining unit may select any one moving route image from moving route images for the point of interest stored in the server based on a preference value.

The apparatus may further include a point-of-interest information processing unit which, when a gaze position value is changed in the moving route image by the driver, generates point-of-interest information including identification information of the moving route image and the gaze position value and transmits the point-of-interest information to the server so that a preference value for the respective moving route images is determined by the server.

The point-of-interest information processing unit may obtain the gaze position value by moving the vehicle or the moving direction indicator of the vehicle which is displayed on an output screen of the moving route image or rotating the vehicle or the indicator at a predetermined direction.

The route guiding control unit may divide a screen on which the driving route is displayed so that the driving route at the point of interest is guided based on the moving route image for the point of interest on any one of divided screens.

The moving route image obtaining unit may determine an expected heading direction of the vehicle based on a current position, a current speed, and a moving direction of the vehicle and obtains the moving route image for the point of interest based on the expected heading direction of the vehicle in real time.

The moving route image obtaining unit determines whether to approach the point of interest and if it is determined to approach the point of interest, obtains the moving route image for the point of interest.

The apparatus may further include a vehicle driving control unit which controls the driving of the vehicle at the point of interest based on the moving route image at the point of interest.

Another exemplary embodiment of the present invention provides a method for guiding a driving route using a photographic image, including: selecting a point of interest on a driving route of a vehicle; obtaining a moving route image for the point of interest based on a photographic image by accessing a server when the point of interest is selected; determining whether the vehicle approaches the point of view; and guiding the driving route at the point of interest based on the moving route image for the point of interest when it is determined that the vehicle approaches the point of interest.

In the obtaining, a telematics function which is mounted in the vehicle is used to access the server.

The obtaining may include obtaining the moving route image at the point of interest obtained by combining a photographic image for the point of interest and an indicator of a moving direction of the vehicle on the driving route based on the current position of the vehicle.

The obtaining may include selecting any one moving route image from moving route images for the point of interest stored in the server based on a preference value.

The method may further include, simultaneously with the obtaining or between the obtaining and the guiding, simultaneously with the guiding, or subsequent to the guiding, generating point-of-interest information including identification information of the moving route image and the gaze position value and transmitting the point-of-interest information to the server when a gaze position value is changed in the moving route image by the driver, so that a preference value for the respective moving route image is determined by the server.

The transmitting may include obtaining the gaze position value by moving the vehicle or the moving direction indicator of the vehicle which is displayed on an output screen of the moving route image or rotating the vehicle or the indicator at a predetermined direction.

The guiding may include dividing a screen on which the driving route is displayed so that the driving route at the point of interest is guided based on the moving route image for the point of interest on any one of divided screens.

The obtaining may include determining an expected heading direction of the vehicle based on a current position, a current speed, and a moving direction of the vehicle and obtains the moving route image for the point of interest based on the expected heading direction of the vehicle in real time

The obtaining may include determining whether to approach the point of interest and if it is determined to approach the point of interest, obtaining the moving route image for the point of interest.

The method may further include, simultaneously with the guiding or subsequent to the guiding, controlling the driving of the vehicle at the point of interest based on the moving route image at the point of interest.

According to the present invention, a driving route at a point of interest is guided based on a photographic image obtained by accessing a server so that the following advantages may be obtained.

First, there is no need to store an image, which is displayed on a divided screen, in a navigation system so that a storage space does not need to be expanded.

Second, an image is transmitted from the server, so that there is no need to separately update the image.

Third, a photographing position and a gaze angle at each point are manipulated by a user or statistics thereof is compiled to be converted to a preferred value by many users so that uneasiness of a driver may be removed.

Fourth, a photograph of a road view is applied to a road image which is shown in the navigation system so that convenience of the driver may be improved.

Fifth, the service is available for most roads of all parts of the country.

### BRIEF DESCRIPTION OF THE DRAWINGS

FIG. 1 is a conceptual view schematically illustrating a photographic image interworking navigation system according to an exemplary embodiment of the present invention.

FIG. 2 is an exemplary diagram of a gaze direction determining method according to a first exemplary embodiment of the present invention.

FIG. 3 is an exemplary diagram of a gaze direction determining method according to a second exemplary embodiment of the present invention.

FIG. 4 is a flowchart illustrating an operating method of a photographic image interworking navigation system according to an exemplary embodiment of the present invention.

FIG. 5 is a block diagram schematically illustrating a driving route guiding apparatus using a photographic image according to an exemplary embodiment of the present invention.

FIG. 6 is a block diagram schematically illustrating a driving route guiding method using a photographic image according to an exemplary embodiment of the present invention.

### DETAILED DESCRIPTION OF THE INVENTION

Hereinafter, exemplary embodiments of the present invention will be described in detail with reference to the accompanying drawings. In the figures, even though the parts are illustrated in different drawings, it should be understood that like reference numbers refer to the same or equivalent parts of the present invention throughout the several figures of the drawing. Furthermore, when it is judged that specific description on known configurations or functions related in the description of the present invention may unnecessarily obscure the essentials of the present invention, the detailed description will be omitted. Further, hereinafter, exemplary embodiments of the present invention will be described. However, it should be understood that the technical spirit of the invention is not limited to the specific embodiments, but may be changed or modified in various ways by those skilled in the art.

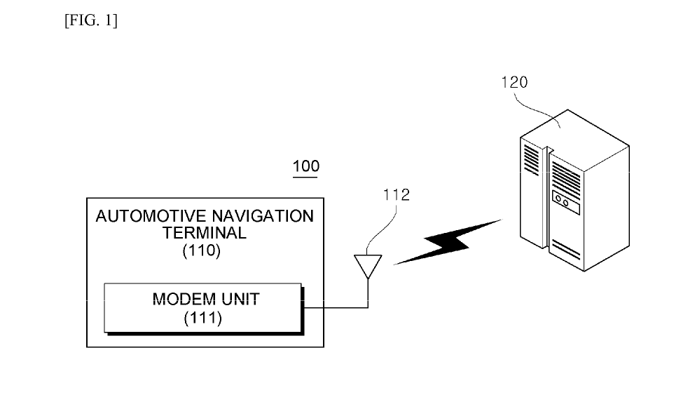

FIG. 1 is a conceptual view schematically illustrating a photographic image interworking navigation system according to an exemplary embodiment of the present invention.

According to an exemplary embodiment of the present invention, a photograph of a road view (street view) is applied as a road image which is displayed in a navigation terminal to assist driving so that convenience is improved. A photograph at a point of interest such as a junction or a destination is downloaded from a server using telematics data communication which is installed in the navigation terminal Further, the navigation terminal also supports the same interface as a road view of a PC so as to allow a user to determine gaze position and direction in the navigation terminal The gaze position and direction determined as described above is transmitted to the server again so as to compile statistics and be converted to a value which is preferred by various users at the corresponding point.

Hereinafter, the present exemplary embodiment will be described in detail with reference to FIG. 1.

A photographic image interworking navigation system 100 includes an automotive navigation terminal 110 and a telematics server 120.

The navigation terminal 110 includes a modem unit 1110 which performs a telematics function therein. As described above, the navigation terminal 110 which includes the modem unit 111 to support the telematics function may perform data communication with the server 120 through an antenna 112 and performs communication at a speed as high as a smart phone. The navigation terminal 110 uses the modem so that a service which is the almost same level as the Internet of the PC is available.

The user uses the navigation terminal 110 to search for a destination and detect a route. The navigation terminal 110 transmits a point of interest and an expected driving direction in the searched route to the server 120. The server 120 transmits the most preferred road view image at each position to the navigation terminal 110. The photograph may be directly operated by the telematics server 120 or may be linked with a map related specialized service provider.

The navigation terminal 110 determines a point which is conveniently determined by a driver such as a departure point, an intersection, and a junction, a toll gate or an entrance/exit ramp as a point of interest. Further, the navigation terminal 110 may add a location which is arbitrarily determined by the user in the middle of a searched route.

The navigation terminal 110 displays the transmitted photographic image of the road view when the vehicle is located at the corresponding position during driving. The navigation terminal 110 replaces a road image which is displayed on the divided screen when the vehicle enters an entrance/exit ramp or an intersection with a photographic image to be shown to the driver. When the photographic image is used, the route may be displayed in the same image as an image which is watched by the driver such as a geographic feature, a building, or a sign and this is helpful for the driver to judge a direction at a complex intersection.

When the navigation terminal 110 interlinks an auxiliary image which is displayed on the divided screen with a road view which is stored in the server 120, a service for most roads in all parts of the country is available. That is, the navigation terminal 110 may provide a service even for an alley through which a vehicle barely passes, in addition to an expressway, a local road, and a complex intersection. Therefore, according to the exemplary embodiment of the present invention, the surrounding geographical feature and building look like real one, and this is helpful for the driver to judge.

A road view image of all parts of the country is stored in the server 120 and the navigation terminal 110 downloads a photographic image only at a required point in the driving route. Therefore, there is no need to add a large quantity of storage in the navigation terminal 110 and the user does not need to separately update an image.

In the case of the road view image which is used in the PC through the Internet, the gaze direction in the position on the map may be moved or a photographing position may be moved. In the prevent invention, the navigation terminal 110 provides a function that controls the road view image through the touch screen using the same interface as the interface of the PC. The road view image which is transmitted to the navigation terminal 110 may also provide the same interface through the screen and the touch screen.

When the road view image which is received from the server 120 is displayed so as to be checked by the user with naked eyes, the navigation terminal 110 sets an initial value (a reference value) of the photographed position or the gaze direction to help the driver to drive.

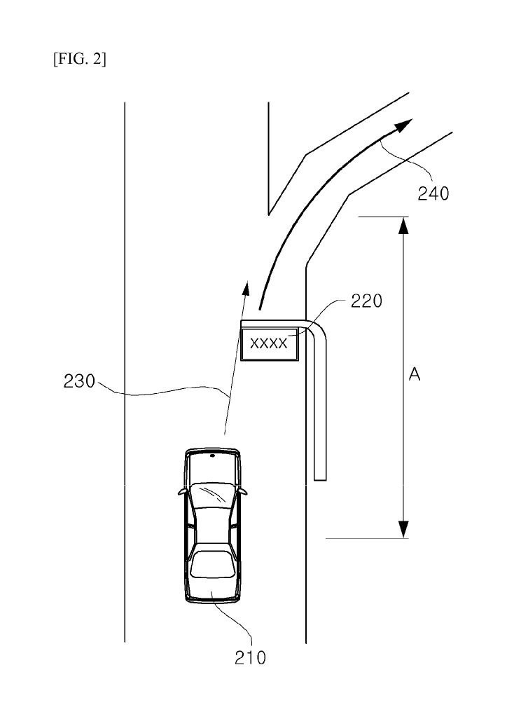

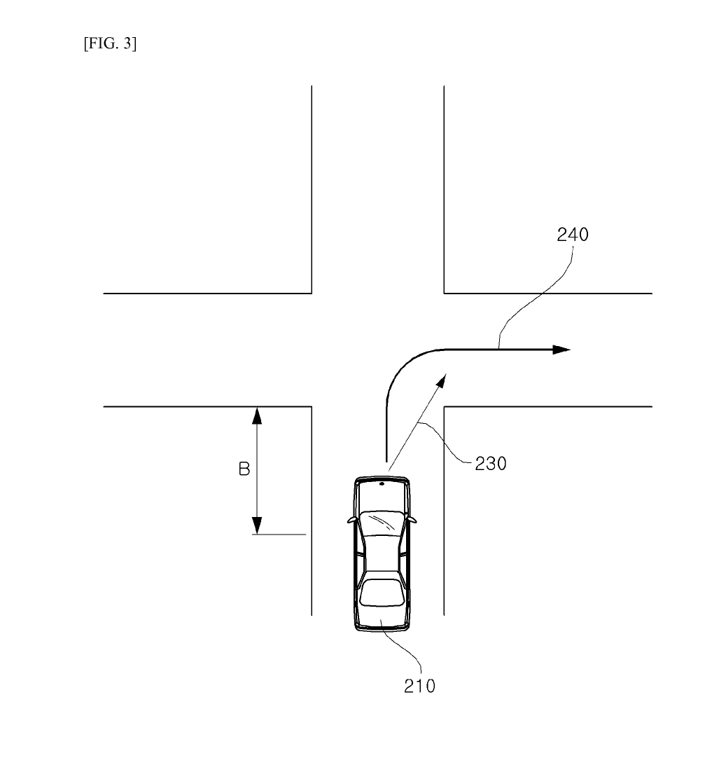

The navigation terminal 110 determines the photographing position or the gaze direction using an expected speed, a current heading direction of the vehicle, and a direction to be driven in the corresponding position. Hereinafter, the exemplary embodiment of the present invention will be described with reference to FIGS. 2 and 3. FIG. 2 is an exemplary diagram of a gaze direction determining method according to a first exemplary embodiment of the present invention and FIG. 3 is an exemplary diagram of a gaze direction determining method according to a second exemplary embodiment of the present invention. FIG. 2 is an example when an exit ramp is at the right side of the expressway and FIG. 3 is an example when the vehicle goes to a three o′clock direction at an intersection of a general road.

In the case of the expressway, the navigation terminal 110 sets the photographing position to 100 m ahead of the exit ramp A or 50 m ahead of the sign 220, as illustrated in FIG. 2. Further, the navigation terminal 100 sets the gaze direction to the vehicle heading direction 240 or a direction 230 which slightly rotates at a right side in the case of the right side exit ramp.

In the case of the intersection of the general road where a speed limit is low, the navigation terminal 110 sets the photographing position to 50 m (B) ahead of the intersection and sets the gaze direction to a two o'clock direction 230 when the heading 240 direction of the vehicle is a three o'clock direction.

In some cases, the user is not satisfied with the initial value of the photographing position or the gaze direction determined as described above. A position where the vehicle already passes by may be selected as the photographing position or an image which is blocked by other vehicle or an obstacle at the time of photographing may be transmitted. Further, a preferred photographing position or gaze direction may vary depending on the users. In this case, since the navigation terminal may provide an interface which is similar to the road view interface which is used in the PC, before departing the vehicle or at the time of stopping the vehicle, the user may arbitrary adjust and store the photographing position or the gaze angle.

The transmitted road view image may be shown on a screen of the navigation terminal 110 with the initial values of the photographing position and the gaze angle which are transmitted from the server 120 at first. When the user is not satisfied with the displayed screen, the user may adjust the photographing position and the gaze angle by him/herself. The image adjusted as described above is stored in the navigation terminal 110 again and the navigation terminal 110 transmits information on the photographing position or the gaze angle determined by the user to the telematics server 120. The telematics server 120 compiles statistics based on the information on the transmitted photographing position or gaze angle to adjust the photographic image so as to be converged to the most preferred direction of the users.

The server 120 stores the collected photographing positions and gaze angles in a database and reflects a value which is selected by the most users in every case as an initial value. By doing this, the server 120 converges the value so that user may use the road view image without any additional adjustment.

As described above, according to the exemplary embodiment of the present invention, a road type which is displayed on a divided screen of the navigation terminal is interlinked with a road view image which is used through the Internet so as to assist the judgment of the driver. Further, according to the exemplary embodiment of the present invention, the user checks the road view image before driving the vehicle to adjust the image to be helpful for the driving and the adjusted value is transmitted to the server so as to be converged to a preferred value of many users.

Next, an operating method of the photographic image interworking navigation system 100 which has been described with reference to FIGS. 1 to 4 will be described.

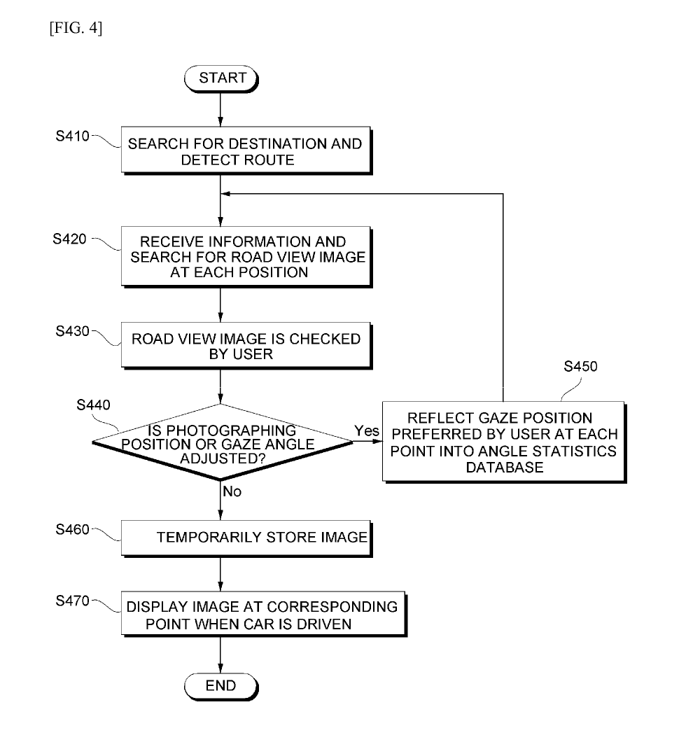

FIG. 4 is a flowchart illustrating an operating method of a photographic image interworking navigation system according to an exemplary embodiment of the present invention.

First, the navigation terminal 110 searches for a destination to detect a route to the destination in step S410. Next, the navigation terminal 110 transmits information on a position of a point of interest and a heading direction on a route to the telematics server 120.

Next, the telematics server 120 searches for a road view image in the position at each point of interest based on the received information in step S420. Next, the telematics server 120 transmits a road view image, a photographing position, and an initial value of a gaze direction to the navigation terminal 110.

Next, the navigation terminal 110 displays the road view image so as to be checked by the user in step S430.

When the user does not request to adjust the photographing position and the gaze angle in step S440, the navigation terminal 110 temporarily stores the image in step S480 and displays the image at the corresponding point during driving in step S470.

In contrast, when the user requests to adjust the photographing position and the gaze angle in step S440, the navigation terminal 110 transmits a position and a viewing angle to the telematics server 120. In this case, the values transmitted from the navigation terminal 110 to the telematics server 120 may be input by the user or measured or calculated.

The telematics server 120 reflects the user's preferred gaze position and angle at each point into a statistic database in step S450 and performs step S420 again.

An exemplary embodiment of the present invention has been described above with reference to FIGS. 1 to 4. Hereinafter, an exemplary embodiment of the present invention which may be deducted from the exemplary embodiment will be described below.

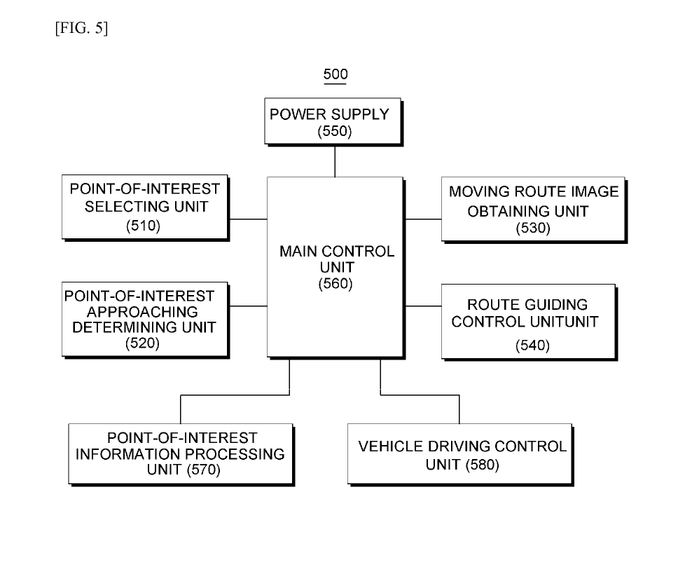

FIG. 5 is a block diagram schematically illustrating a driving route guiding apparatus using a photographic image according to an exemplary embodiment of the present invention. Hereinafter, the description will be made with reference to FIG. 5.

The driving route guiding apparatus 500 according to the exemplary embodiment of the present invention includes a point-of-interest selecting unit 510, a point-of-interest approaching determining unit 520, a moving route image obtaining unit 530, a route guiding control unit 540, a power source 550, and a main control unit 560, as illustrated in FIG. 5.

The driving route guiding apparatus 500 according to an exemplary embodiment of the present invention has the following advantages.

First, the driving route guiding apparatus 500 guides a driving route using a gaze direction and a photographing position of a road view image which are manipulated in the navigation device.

Second, the driving route guiding apparatus 500 directly downloads the road view image based on a photographic image from the server through the Internet using a modem without storing the road view image in the navigation device.

Third, the driving route guiding apparatus 500 provides the same interface as the road view service which is available through the Internet to help the driver or adjust the image to a preferred image.

Fourth, the driving route guiding apparatus 500 feedbacks a parameter which is adjusted by the driver, such as a position where the road view image is photographed or the gaze angle, to the server so as to compile statistics or learn a preferred direction of many users.

The power source 550 supplies a power to individual components of the driving route guiding apparatus 500. The main control unit 560 controls the overall operation of individual components of the driving route guiding apparatus 500. When it is considered that the driving route guiding apparatus 500 is mounted in an AVN system of the vehicle, the power source 550 and the main control unit 560 may be omitted in this exemplary embodiment.

The point-of-interest selecting unit 510 selects a point of interest on a driving route of the vehicle. In this exemplary embodiment, the point of interest includes a junction, an intersection, a three-way intersection, a crossroad, an entrance ramp, an exit ramp, an alley, or a one-way road.

When the point of interest is selected by the point-of-interest selecting unit 510, the moving route image obtaining unit 530 accesses the server to obtain a moving route image for one point of interest based on the photographic image.

The moving route image obtaining unit 530 may access the serer using a telematics function which is installed in the vehicle.

The moving route image obtaining unit 530 obtains a moving route image at the point of interest obtained by combining a photographic image for a point of interest and an indicator of a moving direction of the vehicle on the driving route based on the current position of the vehicle.

The moving route image obtaining unit 530 may select any one moving route image from moving route images for the point of interest stored in the server based on a preference value. The preference value may be input by the driver or selected by the driver. When the preference value is selected by the driver, the moving route image obtaining unit 530 downloads and outputs a list of preference values from the server so that any one value in the list is selected by the driver.

The moving route image obtaining unit 530 determines an expected heading direction of the vehicle based on a current position, a current speed, and a moving direction of the vehicle and obtains a moving route image for the point of interest based on the expected heading direction of the vehicle in real time.

In the meantime, the moving route image obtaining unit 530 determines whether to approach the point of interest and if it is determined to approach the point of interest, obtains the moving route image for the point of interest.

The point-of-interest approaching determining unit 520 determines whether the vehicle approaches the point of interest while the vehicle moves along the driving route.

When the point-of-interest approaching determining unit 520 determines that the vehicle approaches the point of interest, the route guiding control unit 540 guides the vehicle to the driving route at the point of interest based on the moving route image for the point of interest. The route guiding control unit 540 may guide the driving route based on the moving route image for all points on the route without being limited to the point of interest.

The route guiding control unit 540 divides a screen on which the driving route is displayed so that the driving route at the point of interest may be guided based on the moving route image for the point of interest on any one of screens.

The driving route guiding apparatus 500 may further include at least one of a point-of-interest information processing unit 570 and a vehicle driving control unit 580, as illustrated in FIG. 5.

When a gaze position value is changed in the moving route image by the driver, the point-of-interest information processing unit 570 generates point-of-interest information including identification information of the moving route image and the gaze position value and transmits the point-of-interest information to the server so that a preference value for the respective moving route image is determined by the server.

The point-of-interest information processing unit 570 may obtain the gaze position value by moving the vehicle or a moving direction indicator of the vehicle which is displayed on an output screen of the moving route image or rotating the vehicle or the indicator at a predetermined direction.

The vehicle driving control unit 580 controls the driving of the vehicle at the point of interest based on the moving route image at the point of interest.

Next, an operating method of the driving route guiding apparatus described with reference to FIG. 5 will be described.

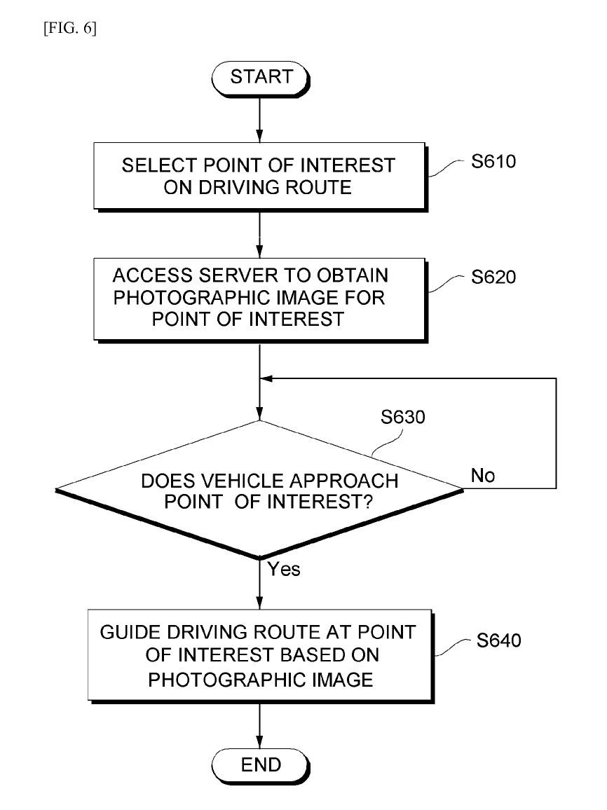

FIG. 6 is a block diagram schematically illustrating a driving route guiding method using a photographic image according to an exemplary embodiment of the present invention. The following description will be made with reference to FIGS. 5 and 6.

First, the point-of-interest selecting unit 510 selects a point of interest on a driving route of the vehicle in step S610.

When the point of interest is selected, the moving route image obtaining unit 530 accesses the server to obtain a moving route image for the point of interest based on a photographic image in step S620. The moving route image obtaining unit 530 may select any one moving route image from moving route images for the point of interest stored in the server based on a preference value.

Next, when the vehicle drives along the driving route, the point-of-interest approaching determining unit 520 determines whether the vehicle approaches the point of interest in step S630.

When it is determined that the vehicle approaches the point of interest, the route guiding control unit 540 guides the driving route at the point of interest based on the moving route image for the point of interest in step S640.

In the meantime, when a gaze position value is changed in the moving route image by the driver, the point-of-interest information processing unit 570 generates point-of-interest information including identification information of the moving route image and the gaze position value and transmits the point-of-interest information to the server so that a preference value for the respective moving route images is determined by the server. This step may be performed between step S620 and step S630 and specifically, may be performed before the vehicle drives.

In the meantime, the vehicle driving control unit 580 controls the driving of the vehicle at the point of interest based on the moving route image at the point of interest. This step may be performed simultaneously with step S640 or subsequently to step S640.

Even though it has been described above that all components of the exemplary embodiment of the present invention are combined as one component or operate to be combined, the present invention is not limited to the exemplary embodiment. In other words, one or more components may be selectively combined to be operated within a scope of the present invention. Further, all components may be implemented as one independent hardware but a part or all of the components are selectively combined to be implemented as a computer program which includes a program module which performs a part or all functions combined in one or plural hardwares. Further, such a computer program may be stored in a computer readable media such as a USB memory, a CD disk, or a flash memory to be read and executed by a computer to implement the exemplary embodiment of the present invention. The recording media of the computer program may include a magnetic recording medium, an optical recording medium, or a carrier wave medium.

If it is not contrarily defined in the detained description, all terms used herein including technological or scientific terms have the same meaning as those generally understood by a person with ordinary skill in the art. A generally used terminology which is defined in a dictionary may be interpreted to be equal to a contextual meaning of the related technology but is not interpreted to have an ideal or excessively formal meaning, if it is not apparently defined in the present invention.

The above description illustrates a technical spirit of the present invention as an example and various changes, modifications, and substitutions become apparent to those skilled in the art within a scope of an essential characteristic of the present invention. Therefore, as is evident from the foregoing description, the exemplary embodiments and accompanying drawings disclosed in the present invention do not limit the technical spirit of the present invention and the scope of the technical spirit is not limited by the exemplary embodiments and accompanying drawings. The protection scope of the present invention should be interpreted based on the following appended claims and it should be appreciated that all technical spirits included within a range equivalent thereto are included in the scope of the present invention.

What is claimed is:

1. An apparatus for guiding a driving route using a photographic image, the apparatus comprising:
a point-of-interest selecting unit which selects a point of interest on a driving route of a vehicle;
a moving route image obtaining unit which, when the point of interest is selected, accesses a server to obtain a moving route image for the point of interest based on a photographic image;
a point-of-interest approaching determining unit which determines whether the vehicle approaches the point of interest; and
a route guiding control unit which, when it is determined that the vehicle approaches the point of interest, guides the driving route at the point of interest based on the moving route image for the point of interest.

2. The apparatus of claim 1, wherein the moving route image obtaining unit accesses the server using a telematics function which is installed in the vehicle.

3. The apparatus of claim 1, wherein the moving route image obtaining unit obtains the moving route image at the point of interest obtained by combining a photographic image for the point of interest and an indicator of a moving direction of the vehicle on the driving route based on the current position of the vehicle.

4. The apparatus of claim 1, wherein the moving route image obtaining unit selects any one moving route image from moving route images for the point of interest stored in the server based on a preference value.

5. The apparatus of claim 1, further comprising:
a point-of-interest information processing unit which, when a gaze position value is changed in the moving route image by the driver, generates point-of-interest information including identification information of the moving route image and the gaze position value and transmits the point-of-interest information to the server so that a preference value for the respective moving route images is determined by the server.

6. The apparatus of claim 5, wherein the point-of-interest information processing unit obtains the gaze position value by moving the vehicle or the moving direction indicator of the vehicle which is displayed on an output screen of the moving route image or rotating the vehicle or the indicator at a predetermined direction.

7. The apparatus of claim 1, wherein the route guiding control unit divides a screen on which the driving route is displayed so that the driving route at the point of interest is guided based on the moving route image for the point of interest on any one of divided screens.

8. The apparatus of claim 1, wherein the moving route image obtaining unit determines an expected heading direction of the vehicle based on a current position, a current speed, and a moving direction of the vehicle and obtains the moving route image for the point of interest based on the expected heading direction of the vehicle in real time.

9. The apparatus of claim 1, wherein the moving route image obtaining unit determines whether to approach the point of interest and if it is determined to approach the point of interest, obtains the moving route image for the point of interest.

10. The apparatus of claim 1, further comprising:
a vehicle driving control unit which controls the driving of the vehicle at the point of interest based on the moving route image at the point of interest.

11. A method for guiding a driving route using a photographic image, the method comprising:
selecting a point of interest on a driving route of a vehicle;
obtaining a moving route image for the point of interest based on a photographic image by accessing a server when the point of interest is selected;
determining whether the vehicle approaches the point of view; and
guiding the driving route at the point of interest based on the moving route image for the point of interest when it is determined that the vehicle approaches the point of interest.

12. The method of claim 11, wherein the obtaining includes obtaining the moving route image at the point of interest obtained by combining a photographic image for the point of interest and an indicator of a moving direction of the vehicle on the driving route based on the current position of the vehicle.

13. The method of claim 11, wherein the obtaining includes selecting any one moving route image from moving route images for the point of interest stored in the server based on a preference value.

14. The method of claim 11, further comprising:
generating point-of-interest information including identification information of the moving route image and a gaze position value and transmitting the point-of-interest information to the server when the gaze position value is changed in the moving route image by the driver, so that a preference value for the respective moving route image is determined by the server.
